(19) United States
(12) Patent Application Publication
(10) Pub. No.: US 2013/0104835 A1
(43) Pub. Date: May 2, 2013

(54) BALANCE SHAFT MODULE OF V6 ENGINE

(71) Applicant: Ahn Lee, Seoul (KR)

(72) Inventor: Ahn Lee, Seoul (KR)

(73) Assignee: Hyundai Motor Company, Seoul (KR)

(21) Appl. No.: 13/534,903

(22) Filed: Jun. 27, 2012

(30) Foreign Application Priority Data
Oct. 31, 2011 (KR) 10-2011-0112095

(51) Int. Cl. F02B 75/06

(52) U.S. Cl. 123/192.2

(57) ABSTRACT

A balance shaft module of a V6 engine increases an engine balancing rate by improving a structure of the balance shaft module and increasing engine balancing of bank angle 70 to 90° of a V6 engine. The balance shaft module of a V6 engine includes a shaft rotating by interworking with a crank shaft of an engine, a balance shaft connected with the shaft via a gear to rotate at the same velocity and reverse direction as the crank shaft and a second balance shaft connected with the shaft via a gear to rotate in a 2X reverse direction with the crank shaft.

### CROSS-REFERENCE TO RELATED APPLICATIONS

The present application claims priority of Korean Patent Application Number 10-2011-0112095 filed Oct. 31, 2011, the entire contents of which application is incorporated herein for all purposes by this reference.

### BACKGROUND OF INVENTION

1. Field of Invention

The present invention relates to a balance shaft module of a V6 engine capable of reducing noise vibrations of an engine due to improved engine balancing while saving costs due to the improved structure of the balance shaft module.

2. Description of Related Art

Generally, a crank shaft of a vehicle needs to be smoothly rotated without vibrations but cannot maintain a balance at the time of rotating since a crank journal center and a crank pin center are eccentric. Therefore, a crank arm at an opposite side of the crank pin is provided with a balance weight (or a counter weight) to maintain a balance during rotation.

However, the above-mentioned method can maintain the balance of the crank shaft, but cannot reduce the vibration of the engine generated during an explosion stroke. The vibration of the engine occurs at various magnitudes depending on the arrangement or number of cylinders.

When the vibration occurs in the engine, the generated vibration is transferred to a vehicle body through an engine mount to generate indoor noises. In order to reduce the vibration, a method for using a balance shaft has been developed.

In order to design the engine balancing, the engine needs to be designed in a structure in which the vector components of reciprocal primary, secondary, and rotational inertial force of the balance shaft are calculated for each engine type and each phase angle of the crank shaft to confirm whether an unbalance force and an unbalance moment of the engine occur and improve the noise, vibration and harshness (NVH) of the engine, thereby offsetting the unbalance components.

Generally, the unbalance force and unbalance moment components of the engine are shown in FIG. 1. In the case of the V6 engine, a recoil moment component in which pitching and yawing moments are combined occurs and an aspect thereof varies according to a cylinder bank angle of the V6 engine.

The V6 engine in which the bank angle is 60° generates the unbalance moment due to the unbalance moment of the reciprocal primary inertial force, the unbalance moment of the reciprocal secondary inertial force, and the unbalance moment component due to a rotational mass. Among others, the reciprocal primary moment and the rotational mass moment component are components rotating in the same velocity/direction as the crank shaft and the magnitude thereof are constant and as a result, the separate balance shaft does not need to be mounted. Therefore, the balancing may be implemented by configuring the balance weight in the crank shaft.

However, the secondary moment component is rotated in a 2× reverse direction with respect to the crank and therefore, the separate balance shaft needs to be mounted.

Further, when the bank angle of the V6 engine is out of 60°, the reverse moment component occurs. As a result, there is a need to apply the balance shaft.

For example, in the case of the V6 engine in which the bank angle is 90°, the unbalance moment due to the reciprocal primary inertial force includes the reverse recoil moment component and as a result, there is a need to mount the separate balance shaft. In addition, the unbalance moment of the reciprocal secondary inertial force also includes the co-directional/reverse recoil moments and therefore, implements 100% balancing only when, two additionally balance shafts need to be mounted. The unbalance moment due to the rotational mass has a crank same velocity and directional component and therefore, the reciprocal primary forward recoil moment and the rotational recoil moment are balanced with the balance weight and the balancing of other components are implemented only when a separate balance shaft is mounted.

As described above, in the case in which the bank angle is out of 60°, the same velocity or 2× rotation as the crank shaft are implemented by mounting the co-directional and reverse rotating balance shaft, which is difficult to apply. Therefore, only the same velocity reverse balance shaft that is most of the primary recoil moment components is applied and the balancing of the secondary recoil moment may not be left.

However, when the balancing of the secondary recoil moment is left, the NVH of the engine may be directly deteriorated. When the magnitude of the unbalancing component also changes 60° of the equivalent V6 engine into 90° of the V6 engine, the engine has about 40% of large moment value and therefore, the NVH may be deteriorated.

Therefore, for the engine in which the bank angle of a V6 engine is in the range of 70 to 90°, 100% balancing may be implemented. Research into the balance shaft module structure having the simple structure should be performed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a balance shaft module of a V6 engine capable of simplifying a structure thereof and saving costs due to an improved structure of a balance shaft module for an engine in which a bank angle of a V6 is in a range of 70 to 90° and increasing an engine balancing rate by offsetting unbalance components, thereby reducing noise vibration (NVH) and improving engine performance.

Various aspects of the present invention provide for a balance shaft module of a V6 engine so as to increase engine balancing of bank angle 70 to 90° of a V6 engine, including a shat rotating by interworking with a crank shaft of an engine, a balance shaft connected with the shaft via a gear to rotate in the same velocity and reverse direction as the crank shaft and a second balance shaft connected with the shaft via a gear to rotate in a 2× reverse direction with the crank shaft.

The balance shaft or the second balance shaft may be provided with an internal oil pump.

The balance shaft module of a V6 engine may further include a third balance shaft connected with the second balance shaft via the gear to rotate in a 2× same direction with the crank shaft.

The balance shaft module of a V6 engine may further include an external oil pump disposed between the driving gears connecting any two of the shaft, the balance shaft, the second balance shaft, and the third balance shaft.

The shaft may be connected and interwork with the crank shaft via the gear.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a unbalance force and unbalance moment aspect of an engine.

FIG. 2 is a perspective view of an exemplary balance shaft module of a V6 engine according to the present invention.

FIG. 3 is a schematic status diagram showing an exemplary balance shaft module of a V6 engine to which an internal oil pump according to the present invention is applied.

FIG. 4 is a perspective view of an exemplary balance shaft module of a V6 engine according to the present invention.

FIG. 5 is a schematic status diagram showing an exemplary balance shaft module of a V6 engine to which an external oil pump according to the present invention is applied.

FIG. 6 is an engine balancing graph in which a bank angle is 72°.

FIG. 7 is an engine balancing graph in which a bank angle is 90°.

FIG. 8 is a diagram showing an oval recoil moment in which the V6 bank angle is 70 to 90°.

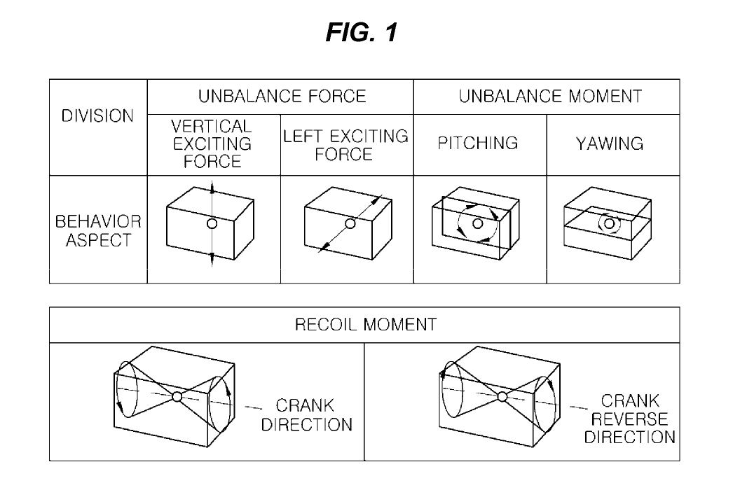

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A balance shaft module of a V6 engine according to exemplary embodiments of the present invention will be described below with reference to accompanying drawings.

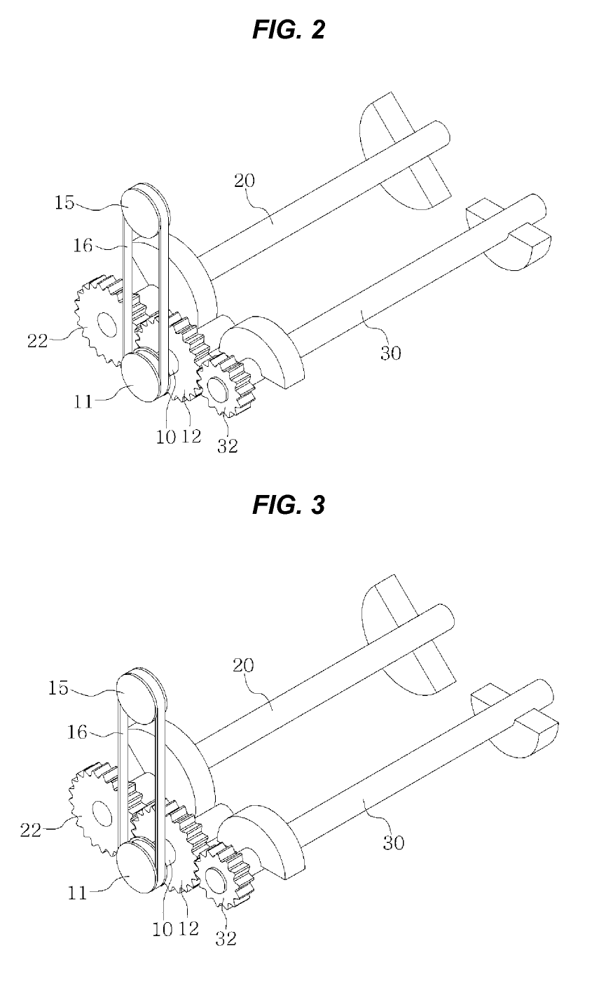

FIG. 2 is a perspective view of a balance shaft module of a V6 engine according to various embodiments of the present invention and FIG. 3 is a schematic status diagram showing a balance shaft module of a V6 engine to which an internal oil pump according to various embodiments of the present invention is applied.

As shown in FIG. 2, a balance shaft module of a V6 engine according to various embodiments of the present invention may include a shaft 10 rotating by interworking with a crank shaft of an engine, a balance shaft 20 rotating in the same velocity and reverse direction as the crank shaft, and a second balance shaft 30 rotating in a 2× reverse direction with the crank shaft, so as to implement the balancing of an engine in which a bank angle of a V6 engine is 70 to 90°.

The crank shaft is provided with a crank sprocket 15, wherein the crank sprocket 15 is connected to a shaft sprocket 11 mounted in the shaft 10 through the driving chain 16. Therefore, the shaft 10 receives a driving force of the crank shaft through the driving chain 16. Meanwhile, the shaft 10 may be connected and interwork with the crank shaft by a gear.

The shaft 10 is provided with a shaft driving gear 12, wherein the shaft driving gear 12 is connected with a balance shaft driving gear 22 provided in the balance shaft 20 through the gear to rotate the balance shaft 20 in a reverse direction with respect to the shaft 10, that is, in a reverse direction with respect to the crank shaft. In this configuration, a gear ratio of the balance shaft driving gear 22 to the shaft driving gear 12 is the same.

Alternatively, a side of the shaft driving gear 12 opposite to a portion engaged with the balance shaft driving gear 22 is connected with a second balance shaft driving gear 32 mounted on the second balance shaft 30 through the gear to rotate the second balance shaft 30 in a reverse direction with respect to the shaft 10, that is, a reverse direction with respect to the crank shaft. In this case, the gear ratio of the second balance shaft driving gear 32 to the shaft driving gear 12 is 2:1 and thus, the balance shaft rotates at a 2× as compared with the crank shaft.

As shown in FIG. 3, an internal oil pump 40 in which a discharged oil amount varies according to a change in a discharge pressure due to a RPM of an engine is mounted on the balance shaft or the second balance shaft.

The internal oil pump rotates is configured to discharge oil through the generated gap while internally contacting each shaft and the detailed structure thereof is already known and therefore, will not be described below.

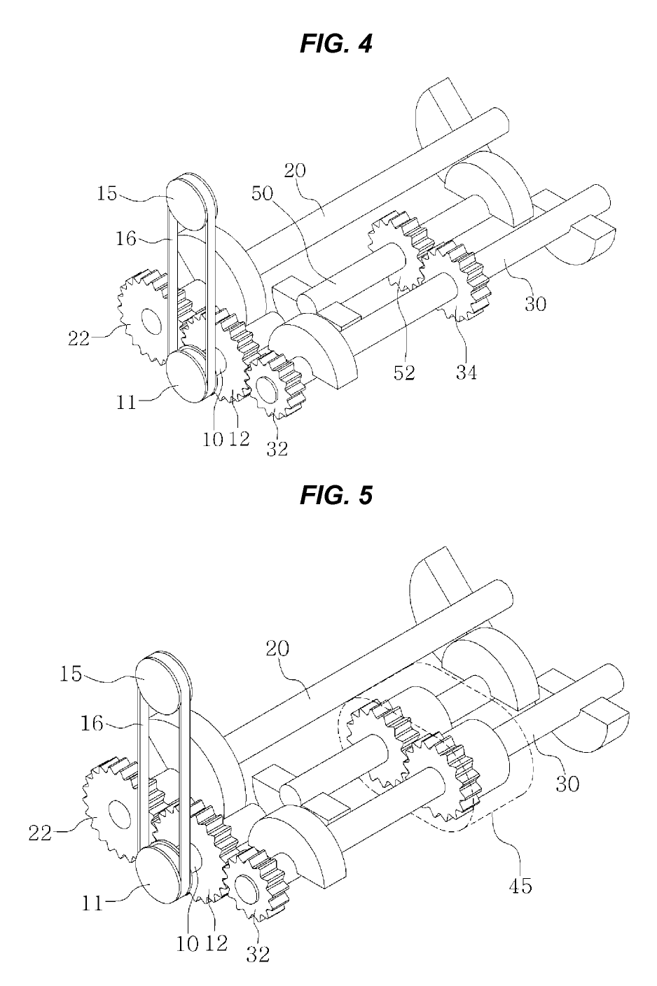

FIG. 4 is a perspective view of a balance shaft module of a V6 engine according to another exemplary embodiment of the present invention and FIG. 5 is a schematic status diagram showing a balance shaft module of a V6 engine to which an external oil pump according to another exemplary embodiment of the present invention is applied.

As shown in FIG. 4, the balance shaft module of a V6 engine may be further provided with a third balance shaft 50 rotating in the 2× co-direction as the crank shaft.

A structure of transferring power to the third balance shaft 50 is connected with the second driving gear 34 provided with the second balance shaft 30 via the gear to transfer power. To this end, the third balance shaft 50 is provided with a third balance shaft driving gear 52 engaged with the second driving gear 34. In this case, the gear ratio of the third balance shaft driving gear 52 to the second driving gear 34 is the same and therefore, the balance shaft rotates at the 2× as compared with the crank shaft as well as rotates in the co-direction as the crank shaft.

When the third balance shaft 50 is mounted, balancing approximating to 100% may be implemented. The third balance shaft 50 has small contribution to the balancing of the engine (about 3%) and therefore, the engine balancing may be increased even when the third balance shaft 50 is not mounted as shown in FIGS. 2 and 3.

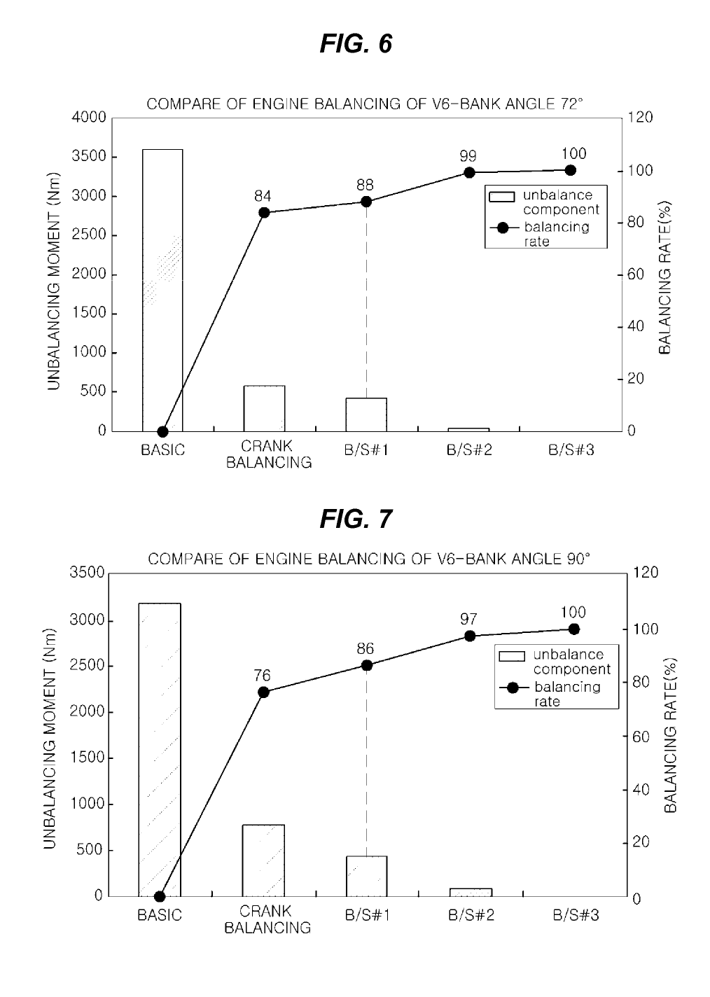

FIG. 6 is an engine balancing graph in which a bank angle according to various embodiments is 72° and FIG. 7 is an engine balancing graph in which a bank angle according to various embodiments is 90°. When three balance shafts are applied, 100% of the balancing rate is implemented and when two balance shafts other than the third balance shaft are applied, 97% of the balancing rate may be implemented.

As shown in FIG. 5, an external oil pump 45 may be provided between the driving gear transferring power by connecting any two of the shaft 10, the balance shaft 20, the second balance shaft 30, and the third balance shaft 50.

The external oil pump, which is a kind of the oil pump in which the discharged oil amount varies according to the change in the discharge pressure due to the RPM of the engine, has a structure in which the gears mounted on the two shafts engages with each other to suck and discharge oil and the detailed structure thereof is known and therefore, will not be described below.

As described above, the balance shaft module may be configured in the simple structure and therefore, the manufacturing costs of the module may be saved.

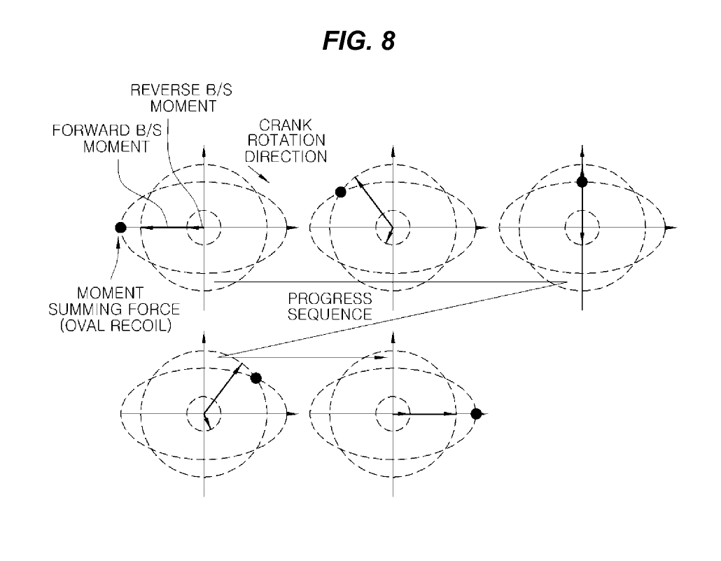

FIG. 8 is a diagram showing an oval recoil moment in which the V6 bank angle according to various embodiments is 70 to 90°. The oval recoil moment is generated to implement the engine balancing. As shown in FIG. 8, various embodiments of the present invention can implement the oval recoil moment by properly combining the co-directional/reverse balance shaft.

As set forth above, the balance shaft module of a V6 engine having the above-mentioned structure can modularize the balance shaft together with one or two oil pumps and simplify the driving layout of the balance shaft to saving costs and can improve the noise vibration (NVH) by increasing the engine balancing rate by mounting at least two balance shafts.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A balance shaft module of a V6 engine so as to increase engine balancing of bank angle 70° to 90° of a V6 engine, comprising:
a rotating shaft operably connected to a crank shaft of an engine;
a first balance shaft connected with the rotating shaft via a first gear to rotate in the same velocity and reverse direction as the crank shaft and
a second balance shaft connected with the rotating shaft via a second gear to rotate in a 2× reverse direction with the crank shaft.

2. The balance shaft module of a V6 engine of claim 1, wherein the first balance shaft or the second balance shaft are provided with an internal oil pump.

3. The balance shaft module of a V6 engine of claim 1, further comprising a third balance shaft connected with the second balance shaft via the second gear to rotate in a 2× same direction with the crank shaft.

4. The balance shaft module of a V6 engine of claim 3, further comprising an external oil pump disposed between the respective gears connecting any two of the rotating shaft, the balance shaft, the second balance shaft, and the third balance shaft.

5. The balance shaft module of a V6 engine of claim 1, wherein the rotating shaft is connected and interworks with the crank shaft via a gear.
